(19) United States
(12) Patent Application Publication
(10) Pub. No.: US 2008/0267291 A1
(43) Pub. Date: Oct. 30, 2008

(54) Method for Deriving Coding Information for High Resolution Images from Low Resolution Images and Coding and Decoding Devices Implementing Said Method

(75) Inventors: Jerome Vieron, Bedee (FR); Edouard Francois, Bourg Des Comptes (FR); Gwenaelle Marquant, La Chapelle Chaussee (FR); Nicolas Burdin, Paris (FR); Patrick Lopez, Livre Sur Changeon (FR); Guillaume Boisson, Rennes (FR)

Correspondence Address: Joseph J. Laks;Thomson Licensing LLC, 2 Independence Way, Patent Operations, PO Box 5312, PRINCETON, NJ, 08543, US

(73) Assignee: Joseph J. Laks Thomson Licensing LLC, Princeton, NJ (US)

(21) Appl. No.: 11/884,493

(22) PCT Filed: Feb. 13, 2006
(86) PCT No.: PCT/EP06/50897

§ 371 Date: Aug. 16, 2007

(30) Foreign Application Priority Data
Feb. 18, 2005 (EP) 05101224.3
Feb. 21, 2005 (FR) 0550477
Mar. 29, 2005 (EP) 05102465.1
Apr. 13, 2005 (EP) 05290819.1

(51) Int. Cl. H04N 7/32; H04N 7/26

(52) U.S. Cl. 375/240.16; 375/240.24; 375/E07.123

(57) ABSTRACT

The invention relates to spatially scalable encoding and decoding processes using a method for deriving coding information. More particularly, it relates to a method for deriving coding information used to encode high resolution images from coding information used to encode low resolution images when the ratio between high resolution and low resolution images dimensions is a multiple of 3/2. The method mainly comprises the following steps:
deriving a block coding mode for each 8×8 blocks of a prediction macroblock MBi_pred from the macroblock coding mode of the associated base layer macroblocks on the basis of the macroblock class of MBi and an the basis of the position of the 8×8 block within MBi_pred;
deriving a macroblock coding mode for MBi_pred from the coding modes of the associated base layer macroblocks; and
deriving motion information for each macroblock MBi_pred from the motion information of the associated base layer macroblocks.

### 1. FIELD OF THE INVENTION

The invention relates to spatially scalable encoding and decoding processes that use a method for deriving coding information. More particularly, it relates to a method, also called inter-layer prediction method, for deriving coding information for high resolution images from the coding information of low resolution images.

### 2. BACKGROUND OF THE INVENTION

State-of-art scalable hierarchical coding methods allow to encode the information hierarchically in order that it can be decoded at different resolution and/or quality levels. A data stream generated by a scalable coding device is thus divided into several layers, a base layer and one or more enhancement layers, also called high layers. These devices allow to adapt a unique data stream to variable transmission conditions (bandwidth, error rate . . . ) and also to the capacities of reception devices (CPU, characteristics of reproduction device . . . ). A spatially scalable hierarchical encoding method encodes (or decodes) a first part of data called base layer relating to low resolution images, and from this base layer encodes (or decodes) at least another data part called enhancement layer relating to high resolution images. The coding information relating to enhancement layer are possibly inherited (i.e. derived) from coding information relating to the base layer by a method called inter-layer prediction method. The derived coding information may possibly comprise: a partitioning pattern associated with block of pixels of the high resolution image (for splitting said block into several sub-blocks), coding modes associated with said blocks, possibly motion vectors and one or more image reference indices associated with some blocks allowing to reference the image used to predict said block. A reference image is an image of the sequence used to predict another image of the sequence. Thus, if not explicitly coded in the data stream, the coding information relating to the enhancement layer has to be derived from the coding information relating to low resolution images. State-of-art methods for deriving coding information cannot be used for high resolution images whose format is not linked to the format of low resolution images by a dyadic transform.

### 3. SUMMARY OF THE INVENTION

The invention relates to a method for deriving coding information for at least one image part of a high resolution image from coding information of at least one image part of a low resolution image, each image being divided into non-overlapping macroblocks themselves divided into non-overlapping blocks of a first size. Non-overlapping sets of three lines of three macroblocks defines hyper-macroblocks and coding information comprises at least macroblock coding modes and block coding modes. According to the invention, at least one macroblock of the at least one low resolution image part, called low resolution macroblock, is associated with each macroblock of the high resolution image part, called high resolution macroblock, so that the associated low resolution macroblock covers at least partly the high resolution macroblock when the low resolution image part upsampled by a predefined ratio multiple of 1,5 in both horizontal and vertical direction is superposed with the high resolution image part. The method comprises the following steps:
deriving a block coding mode for each block of a first size in the high resolution image part, called high resolution block of a first size, from the macroblock coding modes of the low resolution macroblocks associated with the high resolution macroblock to which the high resolution block of a first size belongs, on the basis of the position of the high resolution block of a first size in the high resolution macroblock and on the basis of the position within an hyper-macroblock of the high resolution macroblock, called macroblock class; and/or
deriving a macroblock coding mode for each high resolution macroblock in the high resolution image part from the macroblock coding modes of the low resolution macroblocks associated with the high resolution macroblock on the basis of the class of the high resolution macroblock.

According to a preferred embodiment, a macroblock coding mode of a macroblock is called INTER if the macroblock is predicted temporally for coding or is called INTRA if the macroblock is not predicted temporally for coding. A macroblock coding mode is thus derived for a high resolution macroblock from the macroblock coding modes of the low resolution macroblocks associated with the high resolution macroblock as follows:
if the high resolution macroblock is a center macroblock of an hyper-macroblock, four low resolution macroblocks are associated with the high resolution macroblock, then if the macroblock coding modes of the four low resolution macroblocks are INTRA then the high resolution macroblock coding mode is INTRA else the high resolution macroblock coding mode is INTER;
if the high resolution macroblock is one of the four corner macroblocks of an hyper-macroblock then if the macroblock coding mode of the low resolution macroblock associated with the high resolution macroblock is INTRA then the high resolution macroblock coding mode is INTRA else the high resolution macroblock coding mode is INTER;
if high resolution macroblock is one of the two vertical macroblocks of an hyper-macroblock located above and below the center macroblock of the hyper-macroblock, two low resolution macroblocks are associated with the high resolution macroblock, then if the modes of both the low resolution macroblocks are INTRA then the high resolution macroblock coding mode is INTRA else high resolution macroblock coding mode is INTER.
if high resolution macroblock is one of the two horizontal macroblock of an hyper-macroblock located on the left and on the right of the center macroblock of the hyper-macroblock, two low resolution macroblocks are associated with the high resolution macroblock, then if the modes of both the low resolution macroblocks are INTRA then the high resolution macroblock coding mode is INTRA else high resolution macroblock coding mode is INTER.

Each high resolution macroblock of the high resolution image part is divided in four non-overlapping blocks of a first size arranged in two lines of two blocks, one block located top left, called block B₁, one block located top right, called block B₂, one block located bottom left, called block B₃, one block located bottom right, called block B₄. According to a preferred embodiment, a block coding mode of a block is called INTER if the block is predicted temporally for coding or is called INTRA if the block is not predicted temporally for coding. Advantageously, a block coding mode is derived for each high resolution block of a first size which belong to a center macroblock of an hyper-macroblock from the macroblock coding modes of the four low resolution macroblocks associated with the center macroblock, one low resolution macroblock located top left, called macroblock cMB1, one low resolution macroblock located top right, called macroblock cMB2, one low resolution macroblock located bottom left, called macroblock cMB3, one low resolution macroblock located bottom right, called macroblock cMB4, as follows:
if the macroblock coding mode of cMB1 is INTRA then block coding mode of B1 is INTRA else the block coding mode of B1 is INTER;
if the macroblock coding mode of cMB2 is INTRA then block coding mode of B2 is INTRA else the block coding mode of B2 is INTER;
if the macroblock coding mode of cMB3 is INTRA then block coding mode of B3 is INTRA else the block coding mode of B3 is INTER; and
if the macroblock coding mode of cMB4 is INTRA then block coding mode of B4 is INTRA else the block coding mode of B4 is INTER.

A block coding mode is derived for each high resolution blocks of a first size which belong to a corner macroblock of an hyper-macroblock from the macroblock coding modes of the low resolution macroblock, called macroblock cMB, associated with the corner macroblock as follows:
if the macroblock coding mode of cMB is INTRA then block coding modes of B1, B2, B3 and B4 are INTRA;
else the block coding modes of B1, B2, B3 and B4 are INTER.

A block coding mode is derived for each high resolution blocks of a first size which belong to a vertical macroblock of an hyper-macroblock from the macroblock coding modes of the two low resolution macroblocks associated with the vertical macroblock, one low resolution macroblock located left, called macroblock cMBl, one low resolution macroblock located right, called macroblock cMBr, as follows:
if the macroblock coding mode of cMBl is INTRA then block coding modes of B1 and B3 are INTRA else block coding modes of B1 and B3 are INTER; and
if the macroblock coding mode of cMBr is INTRA then block coding modes of B2 and B4 are INTRA else block coding modes of B2 and B4 are INTER.

A block coding mode is derived for each high resolution blocks of a first size which belong to an horizontal macroblock of an hyper-macroblock from the macroblock coding modes of the two low resolution macroblocks associated with the horizontal macroblock, one low resolution macroblock located top, called macroblock cMBu, one low resolution macroblock located bottom, called macroblock cMBd, as follows:
if the macroblock coding mode of cMBu is INTRA then block coding modes of B1 and B2 are INTRA else block coding modes of B1 and B2 are INTER; and
if the macroblock coding mode of cMBd is INTRA then block coding modes of B3 and B4 are INTRA else block coding modes of B3 and B4 are INTER.

Preferentially, the method further comprises a step for homogenizing block coding modes of blocks of a first size within each high resolution macroblock when the high resolution macroblock contains at least one block of a first size whose block coding mode is INTRA.

Advantageously, coding information further comprises motion information and the method further comprises a step for deriving motion information for each high resolution macroblock from motion information of the low resolution macroblocks associated with the high resolution macroblock.

The step for deriving motion information for a high resolution macroblock comprises the following steps:

associating with each block of a second size in the high resolution macroblock, called high resolution block of a second size, a block of a second size in the low resolution macroblocks associated with the high resolution macroblock, called low resolution block of a second size, on the basis of the class of the high resolution macroblock and on the basis of the position of the high resolution block of a second size within the high resolution macroblock; and

deriving motion information for each block of a second size in the high resolution macroblock from motion information of the low resolution block of a second size associated with the high resolution block of a second size.

Preferentially, the motion information of one block or one macroblock comprises at least one motion vector having a first and a second component and at least one reference index associated with the motion vector selected among a first or a second list of reference indices, the indices identifying reference images.

Advantageously, after the step for deriving motion information, the method further comprises a step for homogenizing, for each high layer macroblock, motion information between sub-blocks of same block of a first size. This step consists, for each list of reference indices, in:

identifying, for each high resolution block of a first size of the high layer macroblock, the lowest index of the sub-blocks among the reference indices of said list of reference indices;

associating the lowest reference index with each of the sub-blocks whose current reference index is not equal to the lowest reference index, the current reference index becoming a previous reference index; and

associating, with each of the sub-block whose previous reference index is not equal to the lowest index, the motion vector of one of its neighboring sub-block whose the previous reference index is equal to the lowest reference index.

Preferentially, the associated motion vector is the motion vector of the first neighboring sub-block encountered when checking first the horizontal neighboring sub-block, secondly the vertical neighboring sub-block and thirdly diagonal neighboring sub-block.

Preferentially, the motion vector components of motion vectors of each high resolution macroblock in the high resolution image part and of each block in high resolution macroblocks if any are scaled by the following equations:

$$\{ \begin{matrix}{d}_{sx} = ( dx * 3 + sign [ {d}_{x} ] ) / 2 \\ {d}_{sy} = ( dy * 3 + sign [ {d}_{y} ] ) / 2\end{matrix}$$

### Where:

dₓ and d_{y} represent the coordinates of the derived motion vector;
dₛₓ and d_{sy} represents the coordinates of the scaled motion vector;
   and
sign[x] is equal to 1 when x is positive and −1 when x is negative.

According to a specific embodiment, predefined ratio equals three divided by two and the blocks of a first size have a size of 8 by 8 pixels, the macroblocks have a size of 16 by 16 pixels, and the blocks of a second size have a size of 4 by 4 pixels.

Preferentially, the method is part of a process for coding video signals and/or is part of a process for decoding video signals.

The invention also relates to a device for coding at least a sequence of high resolution images and a sequence of low resolution images, each image being divided into non-overlapping macroblocks themselves divided into non-overlapping blocks of a first size. It comprises:
first coding means for coding the low resolution images, said first coding means generating coding information for the low resolution images and a base layer data stream;
inheritance means for deriving coding information for at least one image part of a high resolution image from coding information of at least one image part of a low resolution image; and
second coding means for coding the high resolution images using said derived coding information, said second coding means generating an enhancement layer data stream.

Moreover, the invention relates to a device for decoding at least a sequence of high resolution images and a sequence of low resolution images coded with the coding device defined previously, the coded images being represented by a data stream and each image being divided into non-overlapping macroblocks themselves divided into non-overlapping blocks of a first size. It comprises:
first decoding means for decoding at least a first part of the data stream in order to generate low resolution images and coding information of the low resolution images;
inheritance means for deriving coding information for at least one image part of a high resolution image from coding information of at least one image part of a low resolution image; and
second decoding means for decoding at least a second part of the data stream using the derived coding information in order to generate high resolution images.

According to an important feature of the invention, non-overlapping sets of three lines of three macroblocks in said at least one image part of said high resolution image defining hyper-macroblocks and said coding information comprising at least macroblock coding modes and block coding modes, the inheriting means of the coding and decoding devices comprise:
means for associating at least one macroblock of the low resolution image part, called low resolution macroblock, with each macroblock of the high resolution image part, called high resolution macroblock, so that the associated low resolution macroblock covers at least partly the high resolution macroblock when the low resolution image part upsampled by a predefined ratio multiple of 1,5 in both horizontal and vertical direction is superposed with the high resolution image part;
means for deriving a block coding mode for each block of a first size in the high resolution image part, called high resolution block of a first size, from the macroblock coding modes of the low resolution macroblocks associated with the high resolution macroblock to which the high resolution block of a first size belongs, on the basis of the position of the high resolution block of a first size in the high resolution macroblock and on the basis of the position, called macroblock class, of the high resolution within an hyper-macroblock macroblock; and/or
means for deriving a macroblock coding mode for each high resolution macroblock in the high resolution image part from the macroblock coding modes of the low resolution macroblocks associated with the high resolution macroblock on the basis of the class of the high resolution macroblock.

Advantageously, the coding device further comprises a module for combining said base layer data stream and said enhancement layer data stream into a single data stream.

Advantageously, the decoding device further comprises extracting means for extracting said first part of said data stream and said second part of said data stream from said data stream.

### 4. DRAWINGS

Other features and advantages of the invention will appear with the following description of some of its embodiments, this description being made in connection with the drawings in which:

FIG. 1 depicts the geometrical relations between high and low resolution images;

FIG. 2 identifies (grey-colored area) the macroblocks of the high resolution image that can be predicted using inter-layer prediction;

FIG. 3 depicts partitioning and sub-partitioning patterns according to MPEG4 AVC;

FIG. 4 depicts an hyper-macroblock (i.e. 9 enhancement layer macroblocks), the four base layer macroblocks associated with said enhancement layer macroblocks and the upsampled version of these four base layer macroblocks;

FIG. 5 depicts an hyper-macroblock whose macroblocks are labeled with a class (Corner, Vertical, Horizontal and Center) depending on their position within the hyper-macroblock;

FIG. 6 an hyper-macroblock of 9 macroblock superposed with the four upsampled base layer macroblocks associated with them;

FIG. 7 depicts the flowchart of the method according to the invention;

FIG. 8 depicts a macroblock divided into four 8×8 blocks;

FIG. 9 depicts a macroblock divided into 16 4×4 blocks;

FIG. 10 depicts an 8×8 block divided into four 4×4 blocks;

FIG. 11 depicts an encoding device according to the invention; and

FIG. 12 depicts a decoding device according to the invention.

### 5. DETAILED DESCRIPTION OF THE INVENTION

The invention relates to a method for deriving coding information of at least a part of a high resolution from coding information of at least a part of a low resolution image when the ratio between the high resolution image part dimensions and the low resolution image part dimensions are linked with a specific ratio, called inter-layer ratio, equal to 3/2 which corresponds to a non dyadic transform. The method can be extended to inter-layer ratios that are multiple of 3/2. Each image is divided in macroblocks. A macroblock of a low resolution image is called low resolution macroblock or base layer macroblock and is denoted BL MB. A macroblock of a high resolution image is called high resolution macroblock or high layer macroblock and is denoted HL MB. The preferred embodiment describes the invention in the context of spatially scalable coding and decoding and more particularly in the context of spatially scalable coding and decoding in accordance with the standard MPEG4 AVC described in the document ISO/IEC 14496-10 entitled << Information technology—Coding of audio-visual objects—Part 10: Advanced Video Coding >>. In this case, the low resolution images are coded and thus decoded according to the coding/decoding processes described in said document. When coding low resolution images coding information is associated with each macroblock in said low resolution image. This coding information comprises for example partitioning and sub-partitioning of the macroblock in blocks, coding mode (e.g. inter coding mode, intra coding mode . . . ), motion vectors and reference indices. A reference index associated with a current block of pixels allows to identify the image in which the block used to predict current block is located. According to MPE4-AVC, two reference index lists L₀ and L₁ are used. The method according to the invention thus allows to derive such coding information for the high resolution images, more precisely for at least some macroblocks comprised in these images. The high resolution images are then possibly coded using these derived coding information. In this case, the number of bits required to encode the high resolution images is decreased since no coding information is encoded in the data stream for each macroblock whose coding information is derived from low resolution images. Indeed, since the decoding process uses the same method for deriving coding information for the high resolution images, there is no need to transmit it.

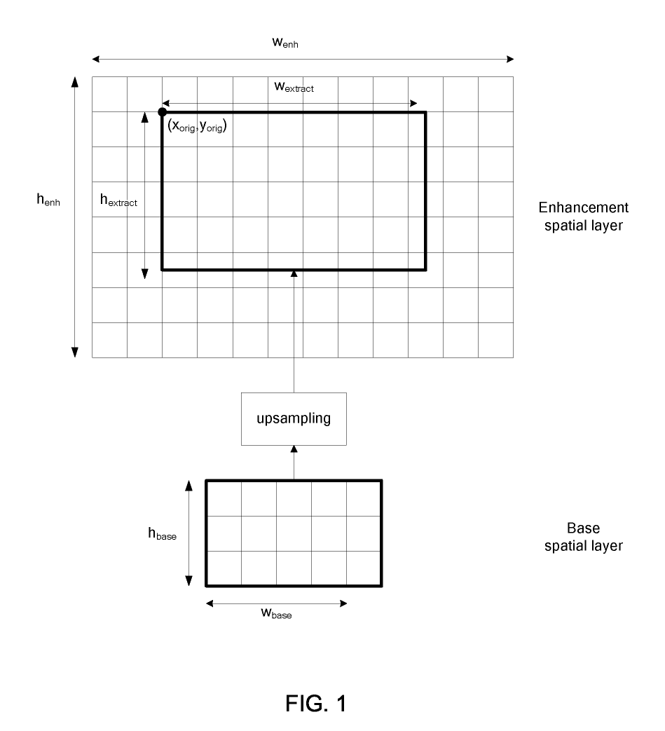

In the sequel, two spatial layers are considered, a low layer (called base layer) corresponding to the images of low resolution and a high layer (called enhancement layer) corresponding to the images of high resolution. The high and low resolution images may be linked by the geometrical relations depicted on the FIG. 1. Width and height of enhancement layer images (i.e. high resolution images) are defined respectively by wₑₙₕ and hₑₙₕ.

Width and height of base layer images (i.e. low resolution images) are defined respectively by w_{base} and h_{base}. Low resolution images may be a downsampled version of sub-images of enhancement layer images, of dimensions W_{extract} and h_{extract}, positioned at coordinates (x_{orig}, y_{orig}) in the enhancement layer images coordinates system. Low and high resolution images may also be provided by different cameras. In this case, the low resolution images are not obtained by downsampling high resolution images and geometrical parameters may be provided by external means (e.g. by the cameras themselves). The values x_{orig} and y_{orig} are aligned on the macroblock structure of the high resolution image (i.e. for a macroblock of size 16 by 16 pixels, x_{orig} and y_{orig} have to be multiple of 16). On FIG. 1, the bold line delimits the part of the high resolution image, called cropping window that is put in correspondence with the low resolution image. More generally, the part of the high resolution image is put in correspondence with a part of the low resolution image. A base layer macroblock is associated with a macroblock of the high resolution image part if when superposing the low resolution image part upsampled by the inter-layer ratio in both directions with the high resolution image part delimited by the cropped window, the associated base layer macroblock covers at least partly the macroblock of the high resolution image. On borders of the enhancement layer image, macroblocks may either have no base layer associated macroblock, or be only partially covered by scaled base layer macroblocks. Consequently a different managing of the inter layer prediction than in the document from the Joint Video Team (JVT) of ISO/IEC MPEG & ITU-T VCEG JVT-N021 entitled “Joint Scalable Video Model JSVM 1”, J. Reichel, H. Schwarz, M. Wien is necessary. This document is referenced as [JSVM1] in the sequel.

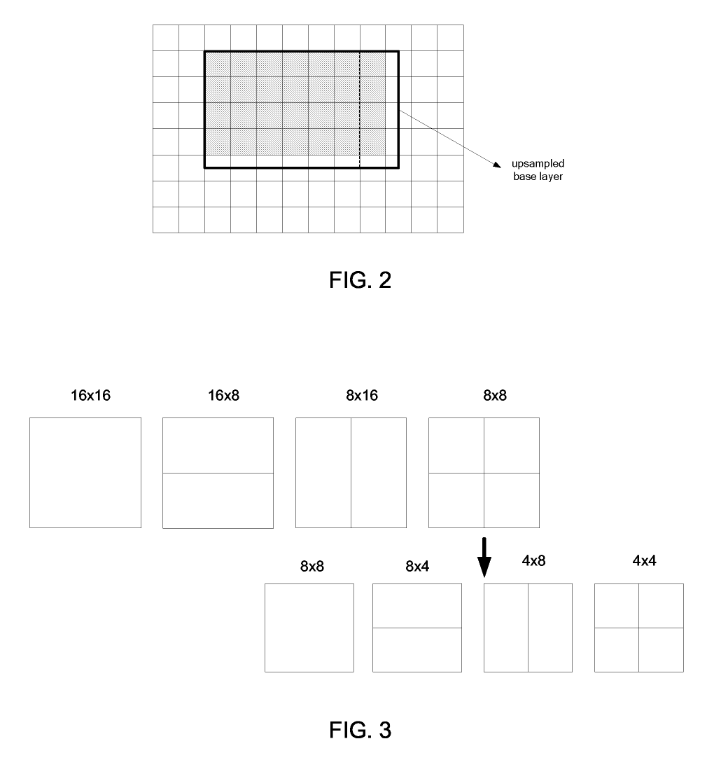

In the context of spatially scalable coding process such as described in [JSVM1], high resolution macroblocks may be coded using classical coding modes (i.e. intra prediction and inter prediction) as those used to encode low resolution images. Besides, some specific macroblocks of high resolution images may use a new mode called inter-layer prediction mode (i.e. inter layer motion and texture prediction). This latter mode is notably authorized for enhancement layer macroblocks fully covered by scaled based layer, that is, whose coordinates (Mbₓ, MB_{y}) verify the following conditions (i.e. grey-colored area in FIG. 2 where bold line represents the upsampled base layer window and delimits the cropping window:

MBₓ>=scaled_base_column_in_mbs and

MBₓ<scaled_base_column_in_mbs+scaled_base_width/16

And

MB_{y}>=scaled_base_line_in_mbs and

MB_{y}<scaled_base_line_in_mbs+scaled_base_height/16

### Where:

scaled_base_column_in_mbs=x_{orig} /16;
scaled_base_line_in_mbs=y_{orig} /16;
scaled_base_width=w_{extract}; and
scaled_base_height=h_{extract}.

Macroblocks that do not follow these conditions may only use classical modes, i.e. intra prediction and inter-prediction modes, while macroblocks following these conditions may use either intra prediction, inter prediction or inter-layer prediction modes. Such enhancement layer macroblock can exploit inter-layer prediction using scaled base layer motion information, using either “BASE_LAYER_MODE” or “QPEL_REFINEMENT_MODE”, as in the case of the macroblock aligned dyadic spatial scalability described in [JSVM1]. When using “QPEL_REFINEMENT_MODE” mode a quarter-sample motion vector refinement is achieved. Afterward, the encoding process will have to decide for each macroblock fully included in the cropping window, which coding mode to select between intra, inter prediction or and inter-layer. Before deciding which mode to finally select, it is required to derive for each macroblock in the grey-colored area the coding information that will be used to predict this macroblock if inter-layer coding mode if finally selected by the encoding process.

The FIG. 3 represents the partitioning of a macroblock in blocks according to MPEG4 AVC. On the first line, macroblocks are represented with the different possible macroblock partition as proposed in MPEG4 AVC (e.g. block of size 16 by 8 pixels, called 16×8 block, block 8 by 16 pixels, called block 8×16, and 8 by 8 pixels, called block 8×8). The second line of FIG. 3 represent blocks of size 8 by 8 pixels (8×8 blocks) with the different possible 8×8 block partition, also called sub-partition, as proposed in MPEG4 AVC. Indeed according to MPEG4 AVC when a macroblock is divided into 4 blocks 8×8, each of said blocks may be further divided in 8×4 sub-blocks, in 8×4 sub-blocks, or in 4×4 sub-blocks.

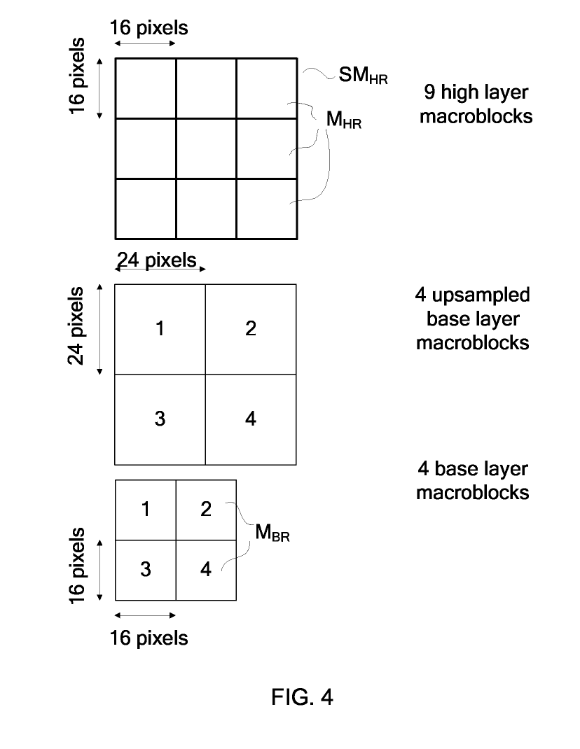

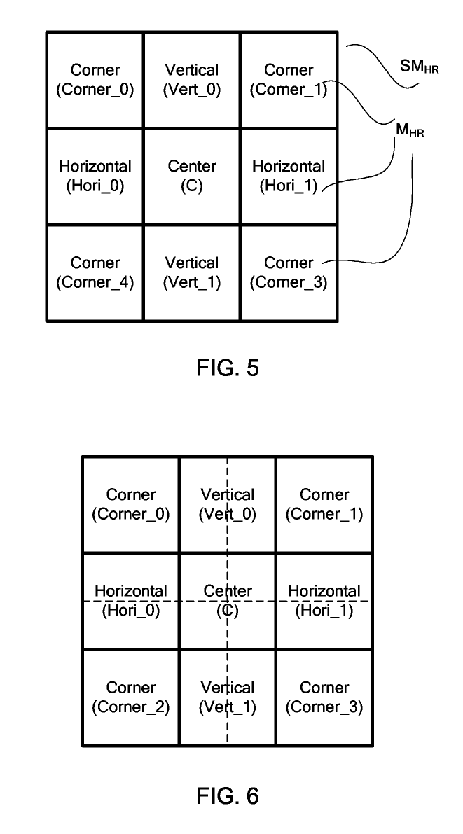

The method for deriving coding information, also called inter-layer prediction, is described in the sequel for a group of nine macroblocks referenced M_{HR} on FIG. 4, called hyper-macrobloc SM_{HR}, of the high resolution image and can be extended directly to the colored grey-area identified on FIG. 2. Assuming the 3/2 ratio, these 9 macroblocks inherit from 4 macroblocks of the base layer as depicted on FIG. 4. More precisely, the method according to the invention consists in determining for each macroblock M_{HR} a possible partition and sub-partition in blocks of smaller size (for example in blocks 8×8, 8×16, 16×8, 8×4, 4×8, or 4×4) and possibly associated parameters (e.g. motion vectors and reference indices) to each block belong to it. The macroblocks enclosed in an hyper-macroblock SM_{HR} can be classified in 4 classes depending on their respective position as depicted on FIGS. 5 and 6. The macroblocks located in the corner of the hyper-macroblock SM_{HR} are referenced Corner_0, Corner_1, Corner_2 and Corner_3, the macroblock located in the center of the hyper-macroblock is referenced C, the macroblocks located on a vertical axe above and below C are referenced Vert_0 and Vert_1, and the macroblocks located on an horizontal axe left and right from C are referenced Hori_0 and Hori_1.

According to a preferred embodiment, a prediction macroblock MBi_pred also called inter-layer motion predictor is associated with each macroblock MBi of an hyper-macroblock. According to another embodiment, a macroblock MBᵢ inherits directly from base layer macroblocks without using such a prediction macroblock. In this case MBi_pred is identified with MBᵢ in the method described below.

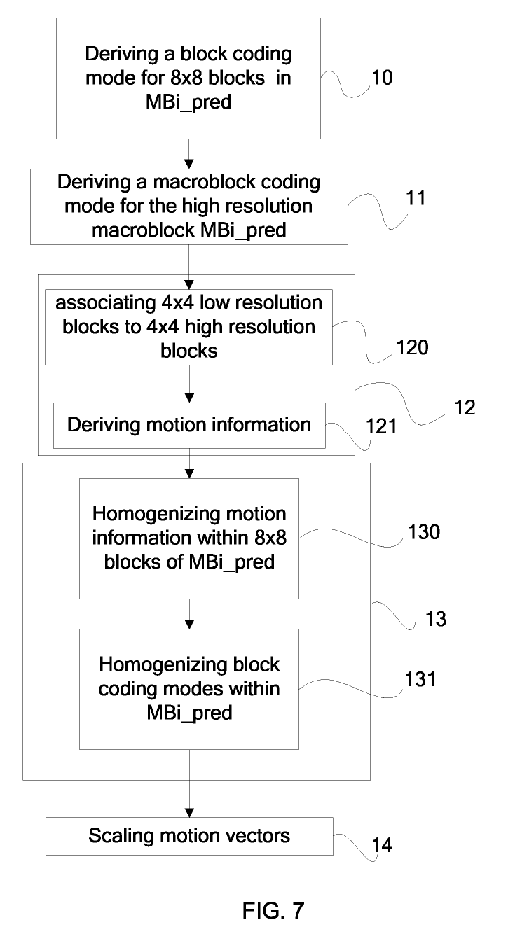

The method for deriving MBi_pred coding information is depicted on FIG. 7 and comprises the steps of:
deriving (10) a block coding mode (also called block label) for each 8×8 blocks of the prediction macroblock MBi_pred from the macroblock coding mode (also called macroblock label) of the associated base layer macroblocks on the basis of the macroblock class of MBi and an the basis of the position of the 8×8 block within the prediction macroblock; and/or
deriving (11) a macroblock coding mode for the prediction macroblock MBi_pred from the coding modes of the associated base layer macroblocks;
deriving (12) motion information (i.e. reference indices and motion vectors) for each prediction macroblock MBi_pred from the motion information of the associated base layer macroblocks:
   associating (120) with each 4×4 block of MBi_pred, a 4×4 base layer block;
   deriving (121) motion information for each 4×4 block of MBi_pred on the basis of the motion information of the associated 4×4 base layer block;
cleaning (13) 8×8 block and macroblock:
   homogenizing motion information (130) within each 8×8 block of MBi_pred by merging reference indices and motion vectors;
   homogenizing block coding modes (131) within MBi_pred by removing isolated 8×8 intra blocks;
scaling (14) motion vectors.

A macroblock coding mode or macroblock label contains information on the type of macroblock prediction, i.e. temporal prediction (INTER) or spatial prediction (INTRA) and for INTER macroblock coding modes it may further contains information on how a macroblock is partitioned (i.e. divided in sub-blocks). The macroblock coding mode INTRA means that the macroblock will be intra coded, while the macroblock coding mode defined as MODE_X_Y means that the macroblock will be predicted and that it is furthermore partitioned into blocks of size X by Y as depicted on FIG. 3. The same description applies to block coding modes defined as INTRA or INTER and for INTER block coding modes as BLK_X_Y.

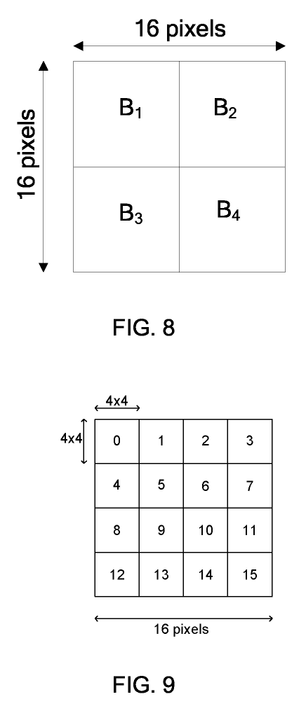

To each macroblock MBi of an hyper-macroblock, is associated a set containing the base layer associated macroblocks as depicted on FIG. 6. More precisely, the nine macroblocks of an hyper-macroblock are superposed with four upsampled base layer macroblocks depending on the geometrical parameters defined previously, i.e. x_{orig} and y_{orig}. To each upsampled base layer macroblock is associated the coding information of the base layer macroblock from which it is upsampled. This upsampling step is not required is just described for sake of clarity. For example, to a macroblock MBi classified as Corner_0 corresponds a single base layer macroblock, the base layer macroblock referenced 1 on FIG. 4, while to a macroblock MBi classified as Vert_0 corresponds two base layer macroblocks, those referenced 1 and 2 on FIG. 4. In the sequel, a base layer macroblock is identified with its upsampled version. Then, according to the mode of these latter macroblocks, a specific block coding mode is derived for each 8×8 block of MBi_pred. This step 10 is referenced as “8×8 block coding mode labelling”. A macroblock coding mode is also directly derived for MBi_pred. This step 11 is referenced as “Macroblock coding mode labelling”. In the following, 8×8 blocks of a macroblock are referenced B1 , B2 , B3, B4 as indicated in FIG. 8. For each MBi of the hyper-macroblock the following process is applied:
IF MBi class is “Corner” THEN,
8×8 block coding mode labelling

As depicted on FIG. 6, a single base layer macroblock, referenced cMB afterward, corresponds to the macroblock MBi. Then according to the mode of cMB, a label for each 8×8 block of MBi_pred is derived as follows:

IF mode[cMB]==INTRA, i.e. the macroblock coding mode associated with cMB is the INTRA mode, THEN all 8×8 blocks are labeled as INTRA blocks

ELSE the 8×8 blocks labels are given by the following table:

| Corner_0 | | B1 | B2 | B3 | B4 |
|---|---|---|---|---|---|
| Corner_1 | | B2 | B1 | B4 | B3 |
| Corner_2 | | B3 | B4 | B1 | B2 |
| Corner_3 | | B4 | B3 | B2 | B1 |
| cMB | MODE_SKIP | BLK_8x8 | BLK_4x8 | BLK_8x4 | BLK_4x4 |
| mode | MODE_8x8 | BLK_8x8 | BLK_4x8 | BLK_8x4 | BLK_4x4 |
| | MODE_8x16 | BLK_8x8 | BLK_4x8 | BLK_8x8 | BLK_4x8 |
| | MODE_16x8 | BLK_8x8 | BLK_8x8 | BLK_8x4 | BLK_8x4 |
| | MODE_16x16 | BLK_8x8 | BLK_8x8 | BLK_8x8 | BLK_8x8 |

Thus for example, if mode[cMB]==MODE_{—}8×16 and if the MBi under consideration is the macroblock referenced Corner_0 on FIG. 5 or 6, the 8×8 block B1 of MBi_pred is thus labeled as BLK_{—}8×8 while the block B2 of MBi_pred is labeled as BLK_{—}4×8.

### Macroblock Coding Mode Labelling

IF mode[cMB]==INTRA THEN, MBi_pred mode is labeled INTRA;

ELSE IF mode[cMB]==MODE_{—}16×16 THEN MBi_pred is labeled MODE_{—}16×16;

ELSE MBi_pred is labeled MODE_{—}8×8.
IF MBi class is “Vertical” THEN,
8×8 block coding mode labelling

As depicted on FIG. 6, two base layer macroblocks correspond to the macroblock MBi. They are referenced cMBl and cMBr (l for left and r for right) in the sequel. Then according to their modes, a label or block coding mode for each 8×8 block of MBi_pred is derived as follows:

IF mode[cMBl]==INTRA, THEN B1 and B3 are labeled as INTRA blocks

ELSE the B1 and B3 labels are directly given by the following table

| | | |
|---|---|---|
| Vert_0 | B1 | B3 |
| Vert_1 | B3 | B1 |

| | | | |
|---|---|---|---|
| cMBl mode | MODE_SKIP | BLK_8x8 | BLK_8x4 |
| | MODE_8x8 | | |
| | MODE_16x8 | | |
| | MODE_16x16 | BLK_8x8 | BLK_8x8 |
| | MODE_8x16 | | |

IF mode[cMBr]==INTRA, THEN B2 and B4 are labeled as INTRA blocks

ELSE B2 and B4 labels are directly given by the following table:

| | | |
|---|---|---|
| Vert_0 | B2 | B4 |
| Vert_1 | B4 | B2 |

| | | | |
|---|---|---|---|
| cMBr mode | MODE_SKIP | BLK_8x8 | BLK_8x4 |
| | MODE_8x8 | | |
| | MODE_16x8 | | |
| | MODE_16x16 | BLK_8x8 | BLK_8x8 |
| | MODE_8x16 | | |

Thus for example, if mode[cMBl]==MODE_{—}8×16, if mode[cMBr]==MODE_{—}8×8 and if the MBi under consideration is the macroblock referenced Vert_0 on FIG. 5 or 6, the 8×8 blocks B1 and B3 of MBi_pred are both labeled as BLK_{—}8×8 while the block B2 of MBi_pred is labeled as BLK_{—}8×8 and the block B2 of MBi_pred is labeled as BLK_{—}8×4.

### Macroblock Coding Mode Labelling

IF mode[cMBl]==INTRA and mode[cMBr]==INTRA THEN, MBi_pred is labeled INTRA;

ELSE IF at least one 8×8 block coding mode is equal to BLK_{—}8×4 THEN MBi_pred is labeled MODE_{—}8×8;

ELSE, IF mode[cMBl]==INTRA or mode[cMBr]==INTRA, THEN MBi_pred is labeled MODE_{—}16×16;

ELSE MBi_pred is labeled MODE_{—}8×16;
IF MBi class is “Horizontal” THEN,
8×8 block coding mode labelling

As depicted on FIG. 6, two base layer macroblocks correspond to the macroblock MBi. They are referenced cMBu and cMBd (u for up and d for down) in the sequel. Then according to their modes, a label for each 8×8 block of MBi_pred is derived as follows:

IF mode[cMBu]==INTRA, THEN B1 and B2 are labeled as INTRA blocks

ELSE the B1 and B2 labels are directly given by the following table:

| | | |
|---|---|---|
| Hori_0 | B1 | B2 |
| Hori_1 | B2 | B1 |

| | | | |
|---|---|---|---|
| u mode | MODE_SKIP | BLK_8x8 | BLK_4x8 |
| | MODE_8x8 | | |
| | MODE_8x16 | | |
| | MODE_16x16 | BLK_8x8 | BLK_8x8 |
| | MODE_16x8 | | |

IF mode[cMBd]==INTRA, THEN B3 and B4 are labeled as INTRA blocks

ELSE B3 and B4 labels are directly given by the following table:

| | | |
|---|---|---|
| Hori_0 | B3 | B4 |
| Hori_1 | B4 | B3 |

| | | | |
|---|---|---|---|
| cMBd mode | MODE_SKIP | BLK_8x8 | BLK_4x8 |
| | MODE_8x8 | | |
| | MODE_8x16 | | |
| | MODE_16x16 | BLK_8x8 | BLK_8x8 |
| | MODE_16x8 | | |

### Macroblock Coding Mode Labelling

IF mode[cMBu]==INTRA and mode[cMBd]==INTRA THEN, MBi_pred is labeled INTRA;

ELSE IF at least one 8×8 block coding mode is equal to BLK_{—}4×8 THEN MBi_pred is labeled MODE_{—}8×8;

ELSE, IF mode[cMBl]==INTRA or mode[cMBr]==INTRA, THEN MBi_pred is labeled MODE_{—}16×16;

ELSE MBi-pred is labeled MODE_{—}16×8.
IF MBi class is “Center” THEN,
8×8 block coding mode labelling

As depicted on FIG. 6, four base layer macroblocks correspond to the macroblock MBi. They are referenced cMB1, cMB2, cMB3 and cMB4 in the sequel (they are the four macroblocks of the base layer associated with the current hyper macroblock and referenced 1, 2, 3 and 4 on FIG. 4). Then according to their modes, a label for each 8×8 block of MBi_pred is derived as follows:

For each Bj
IF mode[cMBj]==INTRA, THEN Bj is labeled as INTRA blocks
ELSE Bj is labeled as BLK_{—}8×8.

### Macroblock Coding Mode Labelling

IF all mode[cMBj] are equal to INTRA THEN, MBi_pred is labeled INTRA;

ELSE MBi_pred is labeled MODE_{—}8×8.

The step 12 consists in deriving for each macroblock MBi_pred motion information from the motion information of its associated base layer macroblocks.

To this aim a first step 120 consists in associating with each 4×4 block of the macroblock MBi_pred, a base layer 4×4 block also called low resolution 4×4 block (from the base layer associated macroblocks). In the following, the 4×4 blocks location within a macroblock are identified by their number as indicated on FIG. 9. For each 4×4 blocks of a macroblock MBi_pred, the associated base layer 4×4 block is defined on the basis of the MBi class and of the number of the 4×4 block within the macroblock MBi_pred as specified in the following tables:

| | | 4x4 Block number of MBi_pred | | | | | | | | | | | | | | | |
|---|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 | 15 |
| MBi Classes | Corner_0 | 0 | 0 | 1 | 2 | 0 | 0 | 1 | 2 | 4 | 4 | 5 | 6 | 8 | 8 | 9 | 10 |
| | Corner_1 | 1 | 2 | 3 | 3 | 1 | 2 | 3 | 3 | 5 | 6 | 7 | 7 | 9 | 10 | 11 | 11 |
| | Corner_2 | 4 | 4 | 5 | 6 | 8 | 8 | 9 | 10 | 12 | 12 | 13 | 14 | 12 | 12 | 13 | 14 |
| | Corner_3 | 5 | 6 | 7 | 7 | 9 | 10 | 11 | 11 | 13 | 14 | 15 | 15 | 13 | 14 | 15 | 15 |
| | Vert_0 | 3 | 3 | 0 | 0 | 3 | 3 | 0 | 0 | 7 | 7 | 4 | 4 | 11 | 11 | 8 | 8 |
| | Vert_1 | 7 | 7 | 4 | 4 | 11 | 11 | 8 | 8 | 15 | 15 | 12 | 12 | 15 | 15 | 12 | 12 |
| | Hori_0 | 12 | 12 | 13 | 14 | 12 | 12 | 13 | 14 | 0 | 0 | 1 | 2 | 0 | 0 | 1 | 2 |
| | Hori_1 | 13 | 14 | 15 | 15 | 13 | 14 | 15 | 15 | 1 | 2 | 3 | 3 | 1 | 2 | 3 | 3 |
| | Center | 15 | 15 | 12 | 12 | 15 | 15 | 12 | 12 | 3 | 3 | 0 | 0 | 3 | 3 | 0 | 0 |

The second table defined below gives the number of the associated macroblock (among the four macroblocks referenced 1, 2, 3, and 4 on FIG. 4) of the low resolution image to which the 4×4 block of the low resolution image identified by the previous table belongs.

| | | 4x4 Block number of MBi_pred | | | | | | | | | | | | | | | |
|---|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 | 15 |
| MBi Classes | Corner_0 | 0 | 0 | 0 | 0 | 0 | 0 | 0 | 0 | 0 | 0 | 0 | 0 | 0 | 0 | 0 | 0 |
| | Corner_1 | 1 | 1 | 1 | 1 | 1 | 1 | 1 | 1 | 1 | 1 | 1 | 1 | 1 | 1 | 1 | 1 |
| | Corner_2 | 2 | 2 | 2 | 2 | 2 | 2 | 2 | 2 | 2 | 2 | 2 | 2 | 2 | 2 | 2 | 2 |
| | Corner_3 | 3 | 3 | 3 | 3 | 3 | 3 | 3 | 3 | 3 | 3 | 3 | 3 | 3 | 3 | 3 | 3 |
| | Vert_0 | 0 | 0 | 1 | 1 | 0 | 0 | 1 | 1 | 0 | 0 | 1 | 1 | 0 | 0 | 1 | 1 |
| | Vert_1 | 2 | 2 | 3 | 3 | 2 | 2 | 3 | 3 | 2 | 2 | 3 | 3 | 2 | 2 | 3 | 3 |
| | Hori_0 | 0 | 0 | 0 | 0 | 0 | 0 | 0 | 0 | 2 | 2 | 2 | 2 | 2 | 2 | 2 | 2 |
| | Hori_1 | 1 | 1 | 1 | 1 | 1 | 1 | 1 | 1 | 3 | 3 | 3 | 3 | 3 | 3 | 3 | 3 |
| | Center | 0 | 0 | 1 | 1 | 0 | 0 | 1 | 1 | 2 | 2 | 3 | 3 | 2 | 2 | 3 | 3 |

A second step 121 consists in inheriting (i.e. deriving) motion information of MBi_pred from base layer associated macroblocks. For each list listx (Lx=0 or 1), the 4×4 block of MBi_pred gets the reference index and motion vector from the associated base layer 4×4 block which has been identified previously by its number. More precisely, the enhancement layer 4×4 block gets the reference index and motion vectors from the base layer block (i.e. partition or sub-partition) to which the associated base layer 4×4 block belongs. For example, if the associated base layer 4×4 block belongs to a base layer macroblock whose coding mode is MODE_{—}8×16, then the 4×4 block of MBi_pred gets the reference index and motion vectors from the base layer 8×16 block to which associated base layer 4×4 block belongs.

According to a specific embodiment, If MBi_pred coding mode is not sub-partitioned (e.g. for example labeled with MODE_{—}16×8), then it is not required to check each 4×4 blocks belonging to it. Indeed, the motion information inherited by one of the 4×4 blocks belonging to one of the macroblock partition (e.g. 16×8 block) may be associated with the whole partition.

According to a preferred embodiment, the step 13 consists in cleaning each MBi_pred in order to remove configurations that are not compatible with a given coding standard, in this case MPEG4 AVC. This step may be avoid if the inheriting method is used by a scalable coding process that does not require to generate a data stream in accordance with MPEG4 AVC.

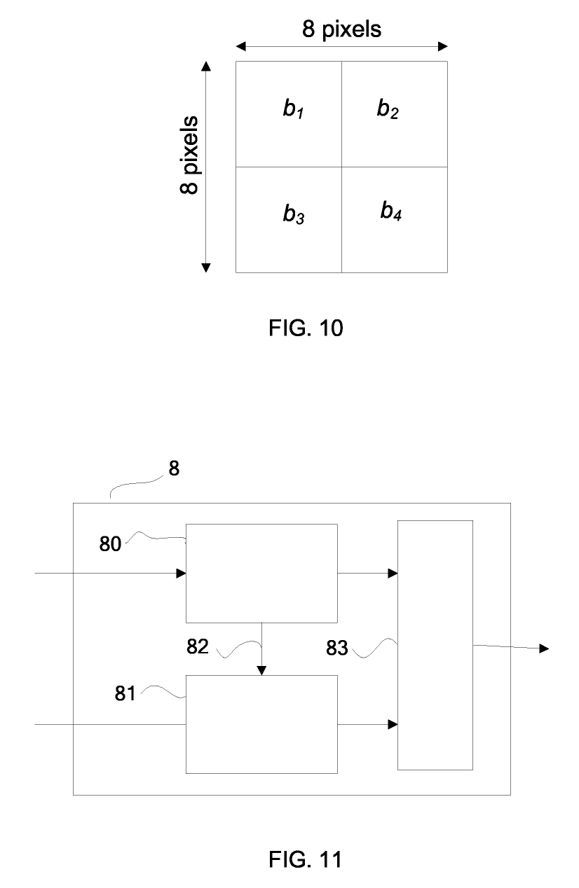

To this aim a step 130 consists in homogenizing the 8×8 blocks of macroblocks MBi_pred with configurations not compatible with MPEG4-AVC standard by removing these 8×8 blocks configurations. For example, according to MPEG4-AVC, for each list, 4×4 blocks belonging to the same 8×8 block should have the same reference indices. The reference indice for a given list Lₓ referenced as r_{bi}(Lx) and the motion vector referenced as mv_{bi}(Lx) associated with a 4×4 block bᵢ within an 8×8 block are thus possibly merged. In the following, each 4×4 blocks bᵢ of an 8×8 block B are identified as indicated in FIG. 10. In the sequel, predictor[B] represents the 4×4 block predictor bᵢ of the 8×8 block B. This predictor[B] is defined as follows:

IF (MBi class is equal to Corner_X (With X=0 . . . 3) or MBi class is equal to Hori_X (With X=0 . . . 1)) THEN,
Predictor[B] is set to b₍ₓ₊₁₎

ELSE, IF (MBi class is equal to Vert_X (With X=0 . . . 1))
Predictor[B] is set to b_{(2*X+1)}

OTHERWISE nothing is done.

For each 8×8 block B (i.e. B₁, B₂, B₃, B₄ as depicted on FIG. 8) of a macroblock MBi_pred, the following reference indices and motion vectors choice is applied:
for each list Lx (i.e. L₀ or L₁)

IF no 4×4 block uses this list, i.e. has no reference index in this list, THEN, no reference index and motion vector of this list are set to B

ELSE, reference index r_{B}(Lx) for B is computed as follows

IF B block coding mode is equal to BLK 8×4 or BLK 4×8 THEN,
IF r_{b1}(Lx) is equal to r_{b3}(Lx) THEN, r_{B}(Lx)=r_{b1}(Lx)
ELSE
Let r_{predictor}(Lx) be the reference index of Predictor[B]
IF r_{predictor}(Lx) is not equal to −1, i.e. is available, THEN, r_{B}(Lx)=r_{predictor}(Lx)
ELSE, IF predictor[B] is equal to b1 THEN, r_{B}(Lx)=r_{b3}(Lx)
ELSE, r_{B}(Lx)=r_{b1}(Lx)

ELSE IF B block coding mode is equal to BLK 4×4
index r_{B}(Lx) for B is computed as the minimum of the existing reference indices of the four 4×4 blocks of B block:

$${r}_{B} ( lx ) = {min}_{b ∈ \{ {b}_{1} , {b}_{2} , {b}_{3} , {b}_{4} \}} ( {r}_{b} ( lx ) )$$

IF (r_{b1}(Lx)!=r_{B}(Lx)) THEN,

r_{b1}(Lx)=r_{B}(Lx)

IF (r_{b2}(Lx)==r_{B}(Lx)) THEN, mv_{b1}(Lx)=mv_{b2}(Lx)

ELSE IF (r_{b3}(Lx)==r_{B}(Lx))THEN, mv_{b1}(Lx)=mv_{b3}(Lx)

ELSE IF (r_{b4}(Lx)==r_{B}(Lx)) THEN, mv_{b1}(Lx)=mv_{b4}(Lx)
IF (r_{b2}(Lx) !=r_{B}(Lx)) THEN,

r_{b2}(Lx)=r_{B}(Lx)

IF (r_{b1}(Lx)==r_{B}(Lx)) THEN, mv_{b2}(Lx)=mv_{b1}(Lx)

ELSE IF (r_{b4}(Lx)==r_{B}(Lx)) THEN, mv_{b2}(Lx)=mv_{b4}(Lx)

ELSE IF (r_{b3}(Lx)==r_{B}(Lx)) THEN, mv_{b2}(Lx)=mv_{b3}(Lx)
IF (r_{b3}(Lx) !=r_{B}(Lx)) THEN,

r_{b3}(Lx)=r_{B}(Lx)

IF (r_{b4}(Lx)==r_{B}(Lx)) THEN, mv_{b3}(Lx)=mv_{b4}(Lx)

ELSE IF (r_{b1}(Lx)==r_{B}(Lx)) THEN, mv_{b3}(Lx)=mv_{b1}(Lx)

ELSE IF (r_{b2}(Lx)==r_{B}(Lx)) THEN, mv_{b3}(Lx)=mv_{b2}(Lx)
IF (r_{b4}(Lx) !=r_{B}(Lx)) THEN,

r_{b4}(Lx)=r_{B}(Lx)

IF (r_{b3}(Lx)==r_{B}(Lx)) mv_{b4}(Lx)=mv_{b3}(Lx)

ELSE IF (r_{b2}(Lx)==r_{B}(Lx)) mv_{b4}(Lx)=mv_{b2}(Lx)

ELSE IF (r_{b1}(Lx)==r_{B}(Lx)) mv_{b4}(Lx)=mv_{b1}(Lx)

A step 131 consists in cleaning (i.e. homogenizing) the macroblocks MBi_pred with configurations not compatible with MPEG4-AVC by removing within these macroblocks the remaining (i.e. isolated) INTRA 8×8 blocks and to enforce them to be INTER 8×8 blocks. Indeed MPEG4 AVC does not allow to have within a macroblock 8×8 INTRA blocks and INTER 8×8 blocks. Step 131 may be applied before step 130. This step is applied to the MBi_pred associated with the macroblocks MBi whose class is Vert_0, Vert_1, Hori_0, Hori_1, or C. In the sequel, Vertical_predictor[B] and Horizontal_predictor[B] represent respectively the vertical and horizontal 8×8 blocks neighbours of the 8×8 block B.

IF mode[MBi]==MODE_{—}8×8 THEN,

For each 8×8 blocks
8×8 blocks whose block coding mode is INTRA are enforced to be INTER blocks with 8×8 partitioning, i.e. are labelled BLK_{—}8×8. Their reference indices and motion vectors are computed as follows. Let B_{INTRA} be such a 8×8 block.

IF Horizontal_predictor[B_{INTRA}] is not classified as INTRA THEN,
for each list lx
   reference index r(lx) is equal to reference index rhoriz(lx) of its horizontal predictor; and
   motion vector mv (lx) is equal to motion vector mvhoriz(lx) of its horizontal predictor.

ELSE, IF Vertical_predictor[B_{INTRA}] is not classified as INTRA THEN,
for each list lx
   reference index r(lx) is equal to reference index rvert(lx) of its vertical predictor; and
   motion vector mv (lx) is equal to motion vector mvvert(lx) of its horizontal predictor.

ELSE,
Clean Horizontal_predictor[B_{INTRA}], i.e. the step 141 is applied on the block Horizontal_predictor[B_{INTRA}];
Clean B_{INTRA}, i.e. the step 141 is applied on the block B_{INTRA}.

The step 14 consists in scaling derived motion vectors. To this aim, a motion vector scaling is applied to every existing motion vectors of the prediction macroblock MBi_pred. A motion vector mv=(dₓ, d_{y}) is scaled using the following equations:

$$\{ \begin{matrix}{d}_{sx} = ( dx * 3 + sign [ {d}_{x} ] ) / 2 \\ {d}_{sy} = ( dy * 3 + sign [ {d}_{y} ] ) / 2\end{matrix}$$

where sign[x] is equal to 1 when x is positive and −1 when x is negative.

Steps 10 to 14 allows to derive coding information for each MBi (or for each corresponding intermediate structure MBi_pred) fully included in the cropping window from the coding information of associated macroblocks and blocks of base layer.

The following optional step consists in predicting texture based on the same principles as inter layer motion prediction. This step may also be referenced as inter layer texture prediction step. It can be possibly used for macroblocks fully embedded in the scaled base layer window cropping window (grey-colored area in FIG. 2). For Intra texture prediction, the interpolation filter is applied across transform blocks boundaries. For residual texture prediction, this process only works inside transform blocks (4×4 or 8×8 depending on the transform).

The process in a decoding device works as follows. Let MBi be an enhancement layer texture macroblock to be interpolated. Texture samples of MBi are derived as follows:

Let (xP, yP) be the position of the upper left pixel of the macroblock in the enhancement layer coordinates reference. A base layer prediction array is first derived as follows:

the corresponding quarter-pel position (x4, y4) of (xP, yP) in the base layer is computed as:

$$\{ \begin{matrix}x 4 = ( {xP}^{*} << 3 ) / 3 \\ Y 4 = ( yP << 3 ) / 3\end{matrix}$$

the integer-pel position (xB, yB) is then derived as:

$$\{ \begin{matrix}xB = x 4 >> 2 \\ yB = y 4 >> 2\end{matrix}$$

the quarter-pel phase is then derived as:

$$\{ \begin{matrix}px = x 4 - xB << 2 \\ py = x 4 - y 4 << 2\end{matrix}$$

The base layer prediction array corresponds to the samples contained in the area (xB-8, yB-8) and (xB+16, yB+16). The same filling process, as used in the dyadic case and described in [JSVM1], is applied to fill samples areas corresponding to non existing or non available samples (for instance, in case of intra texture prediction, samples that do not belong to intra blocks). The base layer prediction array is then upsampled. The upsampling is applied in two steps: first, texture is upsampled using the AVC half pixel 6-tap filter defined in the document JVT-N021 from the Joint Video Team (JVT) of ISO/IEC MPEG & ITU-T VCEG, entitled “Draft ITU-T Recommendation and Final Draft International Standard of Joint Video Specification (ITU-T Rec. H.264 | ISO/IEC 14496-10 AVC)” and written by T. Wiegand, G. Sullivan and A. Luthra, then a bilinear interpolation is achieved to build the quarter pel samples, which results in a quarter-pel interpolation array. For intra texture, this interpolation crosses block boundaries. For residual texture, interpolation does not cross transform block boundaries.

The prediction sample pred[x, y] at each position (x, y), x=0 . . . N−1,y=0 . . . N−1, of the enhancement layer block is computed as:

pred[x, y]=interp[xl, yl]

with

$$\{ \begin{matrix}xI = px + 8 * x / 3 \\ yI = py + 8 * y / 3\end{matrix}$$

interp[xl, yl] is the quarter-pel interpolated base layer sample at position (xl, yl)

### Inter-Layer Intra Texture Prediction

A given macroblock MB of current layer can exploit intra layer residual prediction only if co-located macroblocks of the base layer exist and are intra macroblocks. For generating the intra prediction signal for high-pass macroblocks coded in I_BL mode, the corresponding 8×8 blocks of the base layer high-pass signal are directly de-blocked and interpolated, as in case of ‘standard’ dyadic spatial scalability. The same padding process is applied for deblocking.

### Inter-Layer Residual Prediction

A given macroblock MB of current layer can exploit inter layer residual prediction only if co-located macroblocks of the base layer exist and are not intra macroblocks. At the encoder, the upsampling process consists in upsampling each elementary transform block, without crossing the block boundaries. For instance, if a MB is coded into four 8×8 blocks, four upsampling processes will be applied on exactly 8×8 pixels as input. The interpolation process is achieved in two steps: first, the base layer texture is upsampled using the AVC half pixel 6-tap filter; then a bilinear interpolation, is achieved to build the quarter pel samples. Interpolated enhancement layer samples The nearest quarter pel position is chosen as the interpolated pixel.

The invention concerns a coding device 8 depicted on FIG. 11. The coding device 8 comprises a first coding module 80 for coding the low resolution images. The module 80 generates a base layer data stream and coding information for said low resolution images. Preferentially the module 80 is adapted to generate a base layer data stream compatible with MPEG4 AVC standard. The coding device 8 comprises inheritance means 82 used to derive coding information for high resolution images from the coding information of the low resolution images generated by the first coding module 80. The inheritance means 82 are adapted to implement the steps 10, 11, 12, 13 and 14 of the method according to the invention. The coding device 8 comprises a second coding module 81 for coding the high resolution images. The second coding module 81 uses the coding information derived by the inheritance means 82 in order to encode the high resolution images. The second coding module 81 thus generates an enhancement layer data stream. Preferentially, the coding device 8 also comprises a module 83 (for example a multiplexer) that combines the base layer data stream and the enhancement layer data stream provided by the first coding module 80 and the second coding module 81 respectively to generate a single data stream. The coding information related to the high resolution images are not coded in the data stream since they are derived from the coding information related to the low resolution images that are provided by the module 80. This allows to save some bits.

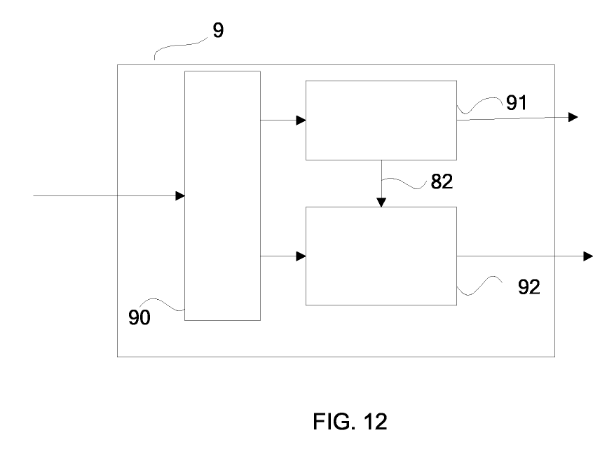

The invention also concerns a decoding device 9 depicted on FIG. 12. This device 9 receives a data stream generated with the coding device 8. The decoding device 9 comprises a first decoding module 91 for decoding a first part of the data stream, called base layer data stream, in order to generate low resolution images and coding information for said low resolution images. Preferentially the module 91 is adapted to decode a data stream compatible with MPEG4 AVC standard. The decoding device 9 comprises inheritance means 82 used to derive coding information for high resolution images from the coding information of the low resolution images generated by the first decoding module 91. The decoding device 9 comprises a second decoding module 92 for decoding a second part of the data stream, called enhancement layer data stream. The second decoding module 92 uses the coding information derived by the inheritance means 82 in order to decode a second part of the data stream. The second decoding module 92 thus generates the high resolution images. Advantageously, the device 9 comprises also an extracting module 90 (e.g. a demultiplexer) for extracting from the received data stream the base layer data stream and the enhancement layer data stream.

According to another embodiment the decoding device receives two data stream: a base layer data stream and an enhancement layer data stream. In this case the device 9 does not comprise an extracting module 90.

The invention is not limited to the embodiments described. Particularly, the invention described for two sequences of images, i.e. two spatial layers, may be used to encode more than two sequences of images.

1-14. (canceled)

15. Method as part of a process of coding or decoding video signal for deriving coding information for at least one image part of a high resolution image from coding information of at least one image part of a low resolution image, each image being divided into non-overlapping macroblocks themselves divided into non-overlapping blocks of a first size, wherein, non-overlapping sets of three lines of three macroblocks in said at least one image part of said high resolution image defining hyper-macroblocks and said coding information comprising at least macroblock coding modes and block coding modes, with each macroblock of said at least one high resolution image part, called high resolution macroblock, is associated at least one macroblock of said at least one low resolution image part, called low resolution macroblock, so that said associated low resolution macroblock covers at least partly said high resolution macroblock when said at least one low resolution image part upsampled by a predefined ratio multiple of 1,5 in both horizontal and vertical direction is superposed with said at least one high resolution image part and in that said method comprises the following steps:
deriving a block coding mode for each block of a first size in said at least one high resolution image part, called high resolution block of a first size, from the macroblock coding modes of the low resolution macroblocks associated with the high resolution macroblock to which said high resolution block of a first size belongs, on the basis of the position of said high resolution block of a first size in said high resolution macroblock and on the basis of the position, called macroblock class, of said high resolution macroblock within an hyper-macroblock; and/or
deriving a macroblock coding mode for each high resolution macroblock in said at least one high resolution image part from the macroblock coding modes of the low resolution macroblocks associated with said high resolution macroblock on the basis of the class of said high resolution macroblock.

16. Method according to claim 15, wherein said method further comprises a step for homogenizing block coding modes of blocks of a first size within each high resolution macroblock when said high resolution macroblock contains at least one block of a first size whose block coding mode is INTRA.

17. Method according to claim 15, wherein said coding information further comprises motion information and wherein said method further comprises a step for deriving motion information for each high resolution macroblock from motion information of the low resolution macroblocks associated with said high resolution macroblock.

18. Method according to claim 17, wherein the step for deriving motion information for a high resolution macroblock comprises the following steps:
associating with each block of a second size in said high resolution macroblock, called high resolution block of a second size, a block of a second size in the low resolution macroblocks associated with said high resolution macroblock, called low resolution block of a second size, on the basis of the class of said high resolution macroblock and on the basis of the position of said high resolution block of a second size within said high resolution macroblock; and
deriving motion information for each block of a second size in said high resolution macroblock from motion information of the low resolution block of a second size associated with said high resolution block of a second size.

19. Method according to claim 17, wherein said motion information of one block or one macroblock comprises at least one motion vector having a first and a second component and at least one reference index associated with said motion vector selected among a first or a second list of reference indices, said indices identifying reference images.

20. Method according to claim 19, wherein, after the step for deriving motion information, the method further comprises a step for homogenizing, for each high layer macroblock, motion information between sub-blocks of same block of a first size and wherein said step consists, for each list of reference indices, in:
identifying, for each high resolution block of a first size of said high layer macroblock, the lowest index of said sub-blocks among the reference indices of said list of reference indices;
associating said lowest reference index with each of said sub-blocks whose current reference index is not equal to said lowest reference index, said current reference index becoming a previous reference index; and
associating, with each of said sub-block whose previous reference index is not equal to said lowest index, the motion vector of one of its neighboring sub-block whose said previous reference index is equal to said lowest reference index.

21. Method according to claim 20, wherein the associated motion vector is the motion vector of the first neighboring sub-block encountered when checking first the horizontal neighboring sub-block, secondly the vertical neighboring sub-block and thirdly diagonal neighboring sub-block.

22. Method according to claim 19, wherein the motion vector components of motion vectors of each high resolution macroblock in said at least one high resolution image part and of each block in high resolution macroblocks if any are scaled by the following equations:
$$\{ \begin{matrix}{d}_{sx} = ( dx * 3 + sign [ {d}_{x} ] ) / 2 \\ {d}_{sy} = ( dy * 3 + sign [ {d}_{y} ] ) / 2\end{matrix}$$
Where:
dₓ and d_{y} represent the coordinates of the derived motion vector;
dₛₓ and d_{sy} represents the coordinates of the scaled motion vector; and
sign[x] is equal to 1 when x is positive and −1 when x is negative.

23. Method according to claim 15, wherein said predefined ratio equals 1.5.

24. Method according to claim 15, wherein said blocks of a first size have a size of 8 by 8 pixels, said macroblocks have a size of 16 by 16 pixels, and said blocks of a second size have a size of 4 by 4 pixels.

25. Device for coding at least a sequence of high resolution images and a sequence of low resolution images, each image being divided into non-overlapping macroblocks themselves divided into non-overlapping blocks of a first size, comprising:
a first coding unit for coding said low resolution images, said first coding unit generating coding information for said low resolution images and a base layer data stream;
an inheritance unit for deriving coding information for at least one image part of a high resolution image from coding information of at least one image part of a low resolution image; and
a second coding unit for coding said high resolution images using said derived coding information, said second coding unit generating an enhancement layer data stream;
wherein, non-overlapping sets of three lines of three macroblocks in said at least one image part of said high resolution image defining hyper-macroblocks and said coding information comprising at least macroblock coding modes and block coding modes, the inheriting unit comprises:
a unit for associating, with each macroblock of said at least one high resolution image part, called high resolution macroblock, at least one macroblock of said at least one low resolution image part, called low resolution macroblock, so that said associated low resolution macroblock covers at least partly said high resolution macroblock when said at least one low resolution image part upsampled by a predefined ratio multiple of 1.5 in both horizontal and vertical direction is superposed with said at least one high resolution image part;
a unit for deriving a block coding mode for each block of a first size in said at least one high resolution image part, called high resolution block of a first size, from the macroblock coding modes of the low resolution macroblocks associated with the high resolution macroblock to which said high resolution block of a first size belongs, on the basis of the position of said high resolution block of a first size in said high resolution macroblock and on the basis of the position, called macroblock class, of said high resolution within an hyper-macroblock macroblock; and/or
a unit for deriving a macroblock coding mode for each high resolution macroblock in said at least one high resolution image part from the macroblock coding modes of the low resolution macroblocks associated with said high resolution macroblock on the basis of the class of said high resolution macroblock.

26. Device according to claim 25, wherein said device further comprises a module for combining said base layer data stream and said enhancement layer data stream into a single data stream.

27. Device for decoding at least a sequence of high resolution images and a sequence of low resolution images coded with the device according to claim 25, the coded images being represented by a data stream and each image being divided into non-overlapping macroblocks themselves divided into non-overlapping blocks of a first size, comprising:
a first decoding unit for decoding at least a first part of said data stream in order to generate low resolution images and coding information of said low resolution images;
an inheritance unit for deriving coding information for at least one image part of a high resolution image from coding information of at least one image part of a low resolution image; and
a second decoding unit for decoding at least a second part of said data stream using said derived coding information in order to generate high resolution images;
wherein, non-overlapping sets of three lines of three macroblocks in said at least one image part of said high resolution image defining hyper-macroblocks and said coding information comprising at least macroblock coding modes and block coding modes, said inheriting unit comprises:
a unit for associating, with each macroblock of said at least one high resolution image part, called high resolution macroblock, at least one macroblock of said at least one low resolution image part, called low resolution macroblock, so that said associated low resolution macroblock covers at least partly said high resolution macroblock when said at least one low resolution image part upsampled by a predefined ratio multiple of 1.5 in both horizontal and vertical direction is superposed with said at least one high resolution image part;
a unit for deriving a block coding mode for each block of a first size in said at least one high resolution image part, called high resolution block of a first size, from the macroblock coding modes of the low resolution macroblocks associated with the high resolution macroblock to which said high resolution block of a first size belongs, on the basis of the position of said high resolution block of a first size in said high resolution macroblock and on the basis of the position within an hyper-macroblock of said high resolution macroblock, called macroblock class; and/or
a unit for deriving a macroblock coding mode for each high resolution macroblock in said at least one high resolution image part from the macroblock coding modes of the low resolution macroblocks associated with said high resolution macroblock on the basis of the class of said high resolution macroblock.

28. Device according to claim 27, wherein said device further comprises an extracting unit for extracting said first part of said data stream and said second part of said data stream from said data stream.
